(19) United States
(12) Patent Application Publication
(10) Pub. No.: US 2006/0170616 A1
(43) Pub. Date: Aug. 3, 2006

(54) 3D image reproduction apparatus

(76) Inventors: Yuzo Hirayama, Yokohama-shi (JP); Kazuki Taira, Tokyo (JP); Hajime Yamaguchi, Yokohama-shi (JP); Rieko Fukushima, Tokyo (JP); Hitoshi Kobayashi, Kawasaki-shi (JP); Goh Itoh, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/614,195

(22) Filed: Jul. 8, 2003

(30) Foreign Application Priority Data
Jul. 8, 2002 (JP) 2002-198753

(51) Int. Cl. G09G 3/00

(52) U.S. Cl. 345/32

(57) ABSTRACT

A 3D image reproduction apparatus including a display and an optical system is described. The display includes a screen on which a plurality of pixels are arranged to display synthesis parallax images in units of arrayed sub regions. Each of the pixels includes three sub pixels that differ in color, and the sub pixels are laid out so that adjacent sub pixels differ in color. The optical system arranged in front of the screen of the display, forms a 3D image from synthesis parallax images displayed on the screen in units of arrayed sub regions.

### CROSS-REFERENCE TO RELATED APPLICATIONS

This application is based upon and claims the benefit of priority from the prior Japanese Patent Application No. 2002-198753, filed Jul. 8, 2002, the entire contents of which are incorporated herein by reference.

### BACKGROUND OF THE INVENTION

1. Field of the Invention

The present invention relates to a 3D image reproduction apparatus which reproduces a 3D image of an object.

2. Description of the Related Art

Three-dimensional display is assumed to be used in various fields such as amusements, Internet shopping, portable terminals, medical cares, virtual reality, and advertising display. Research and development in this field are progressing ever. As a method that makes 3D display possible, a stereoscopic method of displaying 2D images for left and right eyes on a display is known. The stereoscopic method allows an observer to see a 3D vision assuming that he/she observes the 2D image for the right eye with only his/her right eye and the 2D image for the left eye with only his/her left eye.

In the stereoscopic method, the observer must put on, e.g., polarizing glasses such that he/she can observe the 2D image for the right eye with only his/her right eye and the 2D image for the left eye with only his/her left eye. The stereoscopic method produces a 3D vision with a limit observation direction. This method cannot reproduce a 3D image in consideration of observation from multiple directions. For example, even when the observer looks at the side or upper surface of the displayed image, no image corresponding to the direction is displayed. It lacks sense of reality.

Additionally, in the stereoscopic method, the focal point is located on the display surface. A spatial shift is generated between the focal point and a convergent position where the object of gaze is present. Since so-called mismatch between focus adjustment and convergent distance occurs, the observer easily feels sense of incompatibility for the reproduced space and becomes fatigued.

As a 3D image display method that solves the above problems, a method of forming and reproducing a 3D image using a parallax image is disclosed in, e.g., Jpn. Pat. Appln. KOKAI Publication No. 10-239785 or 2001-56450. This method is known as an integral photography method.

An “integral photography method” is based on almost the same principle as that of a beam reproduction method, although its strict meaning as a 3D image display method is not accurately established yet. For example, a method using a pinhole array has been known for a long time as integral photography. The method is also sometimes called a beam reproduction method. In the following explanation, the term “integral photography method” is used as a general term that conceptually includes even the beam reproduction method. Recently, an integral photography method is called an integral imaging method, too.

In an integral photography method, a natural 3D image can be formed using a simple arrangement. In addition, no polarizing glasses are necessary, and a 3D image corresponding to a spatial 3D region is reproduced. For this reason, when the observer changes the observation direction, the 3D image that the observer is seeing also changes in accordance with the change in observation direction. Hence, a 3D image with more reality can be reproduced than 3D vision by the stereoscopic method.

The amount of a light beam emerging from each point of a reproduced 3D image, i.e., the parallax information amount is determined by the number of parallax including images corresponding to respective pinholes. That is, when the number of parallax images is increased, a natural motion parallax can be obtained. The number of pinholes means the number of 2D pixels of the 3D image.

A conventional 3D image reproduction apparatus using an integral photography method comprises a display unit formed from, e.g., a liquid crystal display and a simple optical system formed from a pinhole array having pinholes that are two-dimensionally arrayed. To reproduce an accurate 3D image having a natural motion parallax by the integral photography method, a high-resolution display is necessary as an image display device. Liquid crystal displays (LCDs) whose resolution considerably increases recently are used as such image display devices.

In a normal color liquid crystal display, three primary colors of R, G, and B (sub pixels) are spatially laid out, and other colors are displayed by spatial color mixture. In such a stereoscopic method using sub pixels of three primary colors of R, G, and B, the resolution greatly decreases in the display for 3D image reproduction than in non-3D image display.

For example, assume that a liquid crystal display having a resolution of XGA (extended Graphics Array: number of pixels; 1024×768, and pixel pitch; 150 μm) is applied to a 3D image reproduction apparatus. When the number of horizontal light beams per pinhole is 10, the number of horizontal pixels is 102, and the pixel pitch is 1.5 mm, resulting in a coarse image. This problem of resolution, which is unique to 3D image reproduction, is required to be solved.

### BRIEF SUMMARY OF THE INVENTION

It is an object of the present invention to provide a 3D image reproduction apparatus which can reproduce a 3D image with improved resolution.

A 3D image reproduction apparatus according to one embodiment of the present invention includes a display including a screen on which a plurality of pixels are arranged to display synthesis parallax images in units of arrayed sub regions. The synthesis parallax images are also called an element image in integral photography method. The apparatus also includes an optical system arranged in front of the screen of the display, forming a 3D image from synthesis parallax images displayed on the screen in units of arrayed sub regions. Each of the pixels includes three sub pixels that differ in color. Sub pixels are laid out so that adjacent sub pixels differ in color.

### BRIEF DESCRIPTION OF THE SEVERAL VIEWS OF THE DRAWING

FIG. 1 is a view showing the schematic arrangement of a 3D image reproduction apparatus according to the first embodiment of the present invention;

FIG. 2 is a view showing part of a microlens array and its sectional structure;

FIG. 3 is a view showing the positional relationship between the 3D image reproduction apparatus and a 3D image, which is viewed from the upper side;

FIG. 4 is a view showing focusing of display light in an integral photography method;

FIG. 5 is a view showing focusing of display light in a multinocular scheme;

FIG. 6 is a schematic front view of a pixel layout in the liquid crystal display of the 3D image reproduction apparatus shown in FIG. 1;

FIG. 7 is a view showing a plurality of sub regions corresponding to the pinhole array or microlens array;

FIG. 8 is a front schematic view of the pinhole array corresponding to the pixel layout shown in FIG. 6;

FIG. 9 is a front view of the microlens array in place of the pinhole array;

FIG. 10 is a view showing an arrangement having a slit array in place of the pinhole array;

FIG. 11 is a view showing a plurality of sub regions corresponding to the slit array;

FIG. 12 is a schematic front view of the slit array corresponding to the pixel layout shown in FIG. 11;

FIG. 13 is a front view of a lenticular sheet in place of the slit array;

FIG. 14 is a view showing the pixel layout so as to explain color flicker in RGB color mixture;

FIG. 15 is a view showing a slit array corresponding to the pixel layout shown in FIG. 14 so as to explain color flicker in RGB color mixture;

FIG. 16 is a schematic front view of a pixel layout in a liquid crystal display according to the second embodiment of the present invention;

FIG. 17 is a schematic front view of a pinhole array combined with the pixel layout shown in FIG. 16;

FIG. 18 is a view showing a slit array which is used in place of the pinhole array shown in FIG. 17 in correspondence with the pixel layout shown in FIG. 16;

FIG. 19 is a schematic front view of a pixel layout in a liquid crystal display according to the third embodiment of the present invention;

FIG. 20 is a schematic front view of a pinhole array corresponding to the pixel layout shown in FIG. 19; and

FIG. 21 is a view showing a slit array which is used in place of the pinhole array shown in FIG. 20 in correspondence with the pixel layout shown in FIG. 19.

### DETAILED DESCRIPTION OF THE INVENTION

A 3D image reproduction apparatus according to the present invention will be described below in detail with reference to the accompanying drawing.

### First Embodiment

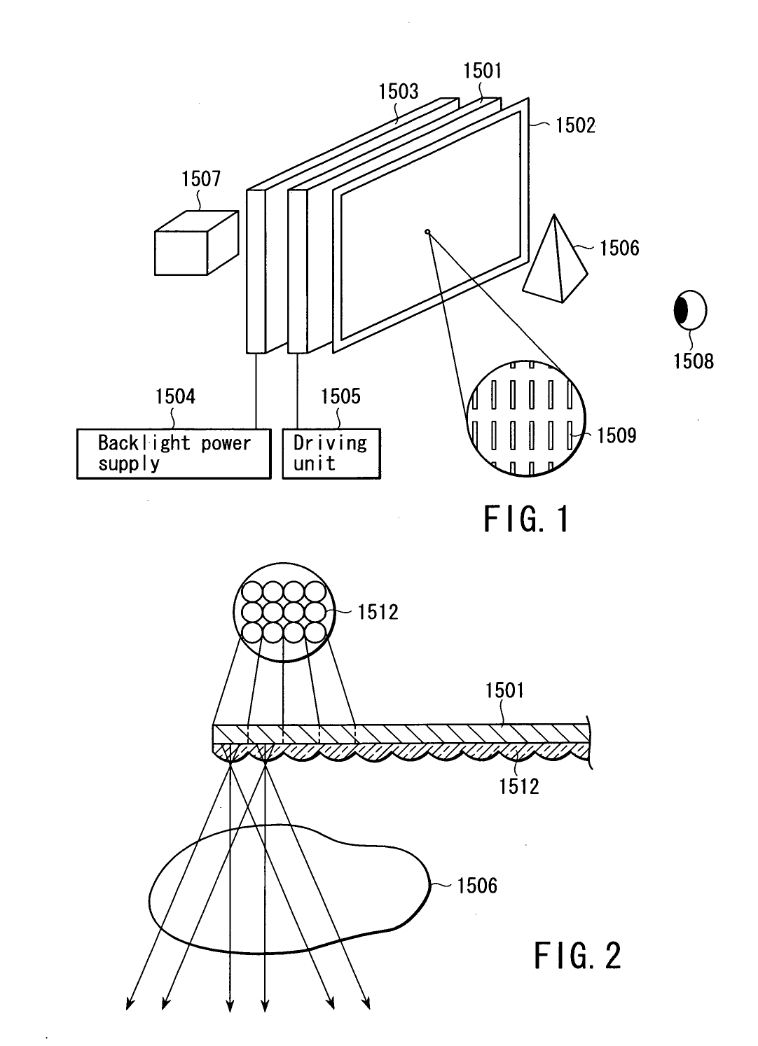

FIG. 1 is a view showing the schematic arrangement of a 3D image reproduction apparatus according to the first embodiment of the present invention. This apparatus employs an integral photography method.

A liquid crystal display 1501 has a color liquid crystal display screen in which sub pixels of three primary colors of R, G, and B are two-dimensionally laid out in a matrix, as will be described later. The liquid crystal display 1501 is electrically driven by a driving unit 1505 to display a synthesis parallax image that forms a 3D image. A backlight 1503 is arranged on the rear side of the liquid crystal display 1501. Light emitted from the backlight 1503 illuminates the display screen of the liquid crystal display 1501.

A pinhole array 1502 is arranged on the opposite side of the backlight 1503, i.e., between an observer and the display screen of the liquid crystal display 1501. A 3D real image 1506 is reproduced by light beams emerging from pinholes 1509 of the pinhole array 1502 and recognized by an observing eye 1508. When the light beams are traced from the pinhole array 1502 in a direction reverse to the 3D real image 1506, a 3D virtual image 1507 can be reproduced. In addition, 3D images can be continuously reproduced in front and behind of the pinhole array 1502.

A microlens array 1512 may be used in place of the pinhole array 1502, as shown in FIG. 2. The microlens array 1512 is formed by two-dimensionally arraying very small lenses and has a sectional structure as shown in FIG. 2. Light emerging from a color filter portion corresponding to each sub pixel of the liquid crystal display 1501 is refracted by the microlens array 1512 and propagates to a specific direction. The microlens array 1512 functions like the pinhole array 1502. However, when the microlens array 1512 is used, the luminance becomes higher than in the arrangement using the pinhole array 1502.

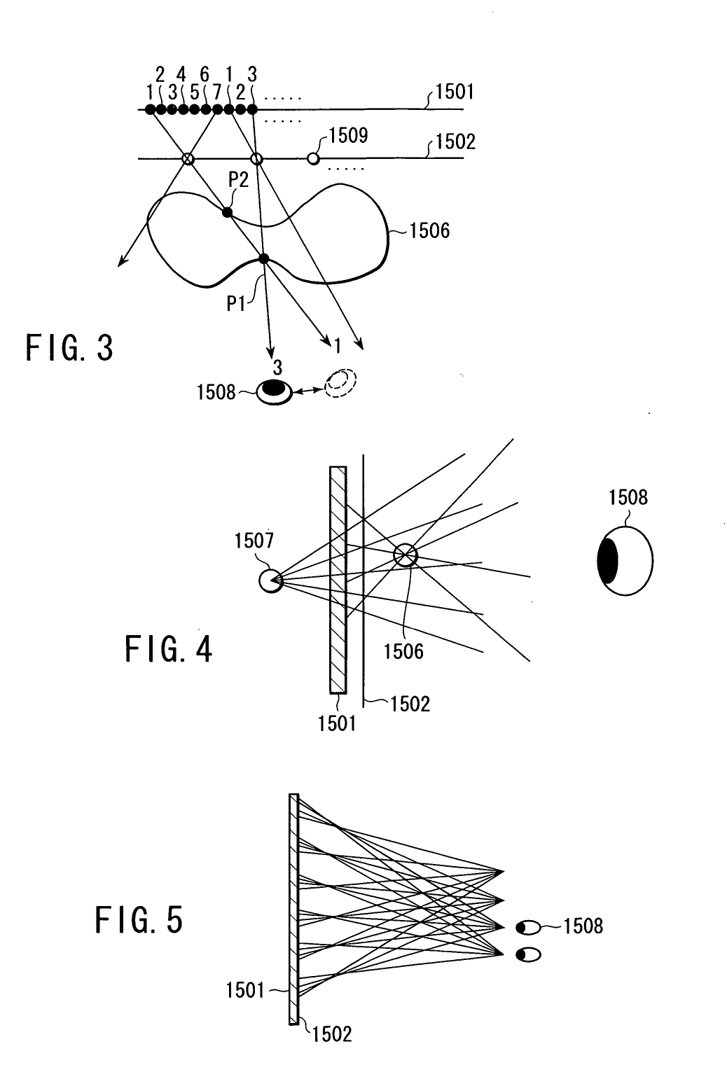

FIG. 3 is a view showing the positional relationship between the 3D image reproduction apparatus shown in FIG. 1 and a 3D image, which is viewed from the upper side. The liquid crystal display 1501 arranged on the rear side of the pinhole array 1502 when viewed from the observer 1508 side displays synthesis parallax images whose appearances delicately change in accordance with the viewing angle from the observer 1508 to the pinhole array 1502. The synthesis parallax images are calculated by a raytracing method used in computer graphics well.

Light beams emerging from the synthesis parallax images become a number of parallax image light beams through the pinhole 1509. The real image 1506 (3D image) is reproduced by focusing the light beams.

In the liquid crystal display 1501 which two-dimensionally displays synthesis parallax images, the minimum driving unit is each of the sub pixels of R (red), G (green), and B (blue). A color can be reproduced by three sub pixels of R, G, and B.

Each sub pixel displays the information of the luminance and color of a point at which a straight line that extends from the sub pixel through the center of the pinhole 1509 crosses the 3D image on the display space. Generally, there are a plurality of “points at which the 3D image crosses” a straight line that extends from a single sub pixel through a single pinhole 1509. However, a display point is defined as a point closest to the observer side. For example, referring to FIG. 3, a point P1 closer to the observing eye 1508 than a point P2 is defined as a display point.

The display luminance value of each sub pixel is calculated by a Method raytracing on the basis of the luminances of R, G, and B components for the point where the straight line that extends from the sub pixel through the center of the pinhole 1509 crosses the 3D image to be displayed. More specifically, in 24-bit color display, as the luminance of an R sub pixel, the R component (having a numerical value from 0 to 255) of a corresponding color value is used. As the luminance of a G sub pixel, the G component (having a numerical value from 0 to 255) of a corresponding color value is used. As the luminance of a B sub pixel, the B component (having a numerical value from 0 to 255) of a corresponding color value is used. Thus, the color of the 3D image can be reproduced.

This also applies to the arrangement using the microlens array 1512 shown in FIG. 2. Each sub pixel displays the information of the luminance and color of a point at which a straight line that extends from the sub pixel through the center of a lens crosses the 3D image on the display space. The display luminance value of each sub pixel is calculated on the basis of the luminances of R, G, and B components for the point where the straight line that extends from the sub pixel through the center of the lens crosses the 3D image to be displayed. More specifically, in 24-bit color display, as the luminance of an R sub pixel, the R component (having a numerical value from 0 to 255) of a corresponding color value is used. As the luminance of a G sub pixel, the G component (having a numerical value from 0 to 255) of a corresponding color value is used. As the luminance of a B sub pixel, the B component (having a numerical value from 0 to 255) of a corresponding color value is used.

In an integral photography method, light beams are not focused at the observer position 1508, as shown in FIG. 4. There is also a scheme called a multinocular scheme for focusing light beams to the eyepoint position of the observer. An arrangement of the multinocular scheme is shown in FIG. 5. Generally, in multinocular scheme, light beams are focused at space of 65 mm degree, i.e. space between eyes. In the multinocular scheme, a “flipping” may sometimes occur as the observer 1508 moves. However, when the eyepoint position is limited, a satisfactory 3D vision can be obtained. The liquid crystal display which is arranged behind the pinhole array, displays a set of synthesis parallax images. The images are prepared in advance by interleaving a plurality of image regions into which each of a plurality of multi-viewpoint images are divided. A stereoscopic vision can be demonstrated when the synthesis parallax images whose appearances delicately change in accordance with the viewing angle from the observer to the pinhole array are displayed. The observer observes the parallax images with his/her left eye and right eye. The present invention can also be applied to a 3D image reproduction apparatus that employs the multinocular scheme.

This embodiment has the following arrangement such that a natural 3D image having a high resolution can be reproduced by the 3D image reproduction apparatus without any color flicker in RGB color mixture.

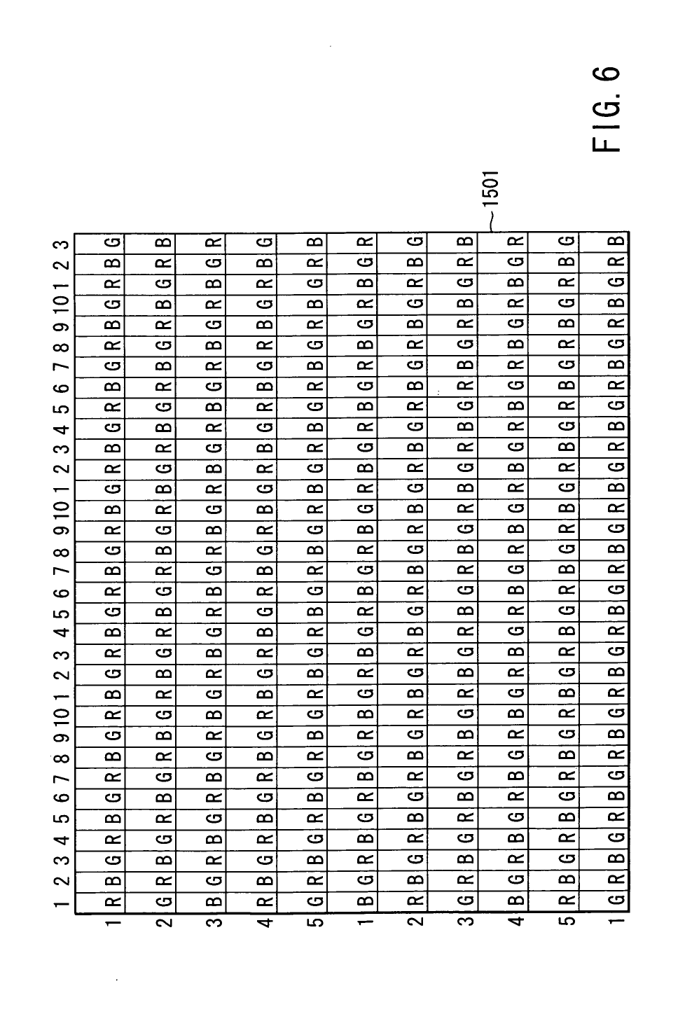

FIG. 6 is a schematic front view of a pixel layout in the liquid crystal display of the 3D image reproduction apparatus shown in FIG. 1.

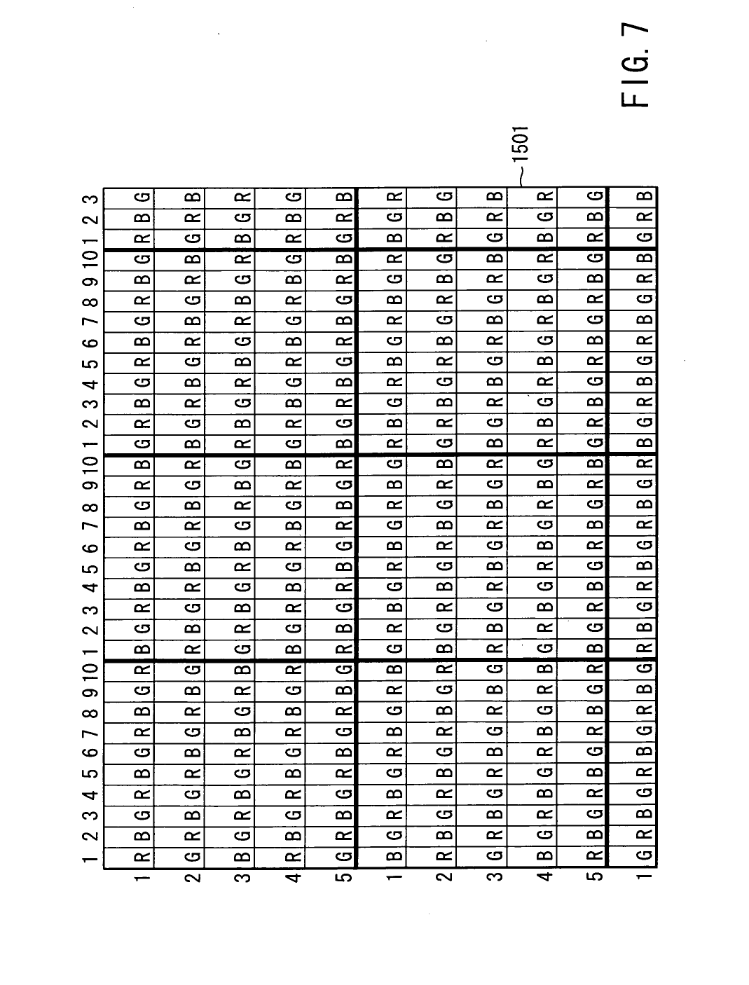

As shown in FIG. 6, the sub pixel array has numbers (suffixes) in the horizontal and vertical directions. The numbers represent parallaxes (or viewpoints in multinocular scheme) corresponding to the sub pixel array. One sub pixel has a width of 50 μm and a length of 150 μm. In the horizontal directions, first to 10th parallaxes are assigned to the sub pixels. In the vertical direction, first to fifth parallaxes are assigned to the sub pixels. In FIG. 7, a plurality of sub regions corresponding to the pinhole array or microlens array are indicated by bold lines for the descriptive convenience. The liquid crystal display 1501 displays synthesis parallax images in units of arrayed sub regions. The pinhole array or microlens array passes the display light of the parallax images displayed by the liquid crystal display 1501 to form a 3D image.

In this embodiment, the sub pixels are periodically laid out in the liquid crystal display 1501, as shown in FIG. 6. One pixel comprises three sub pixels corresponding to a first red picture element (R), second green picture element (G), and third blue picture element (B). Each sub pixel has a rectangular shape long in the vertical direction of the display screen of the liquid crystal display 1501. A color can be reproduced by the three sub pixels, i.e., the first red picture element (R), second green picture element (G), and third blue picture element (B). In this embodiment, sub pixels of different colors are laid out to be adjacent to each other while sharing the sides of the rectangles. In other words, sub pixels of the same color are not laid out adjacent to each other while sharing their sides.

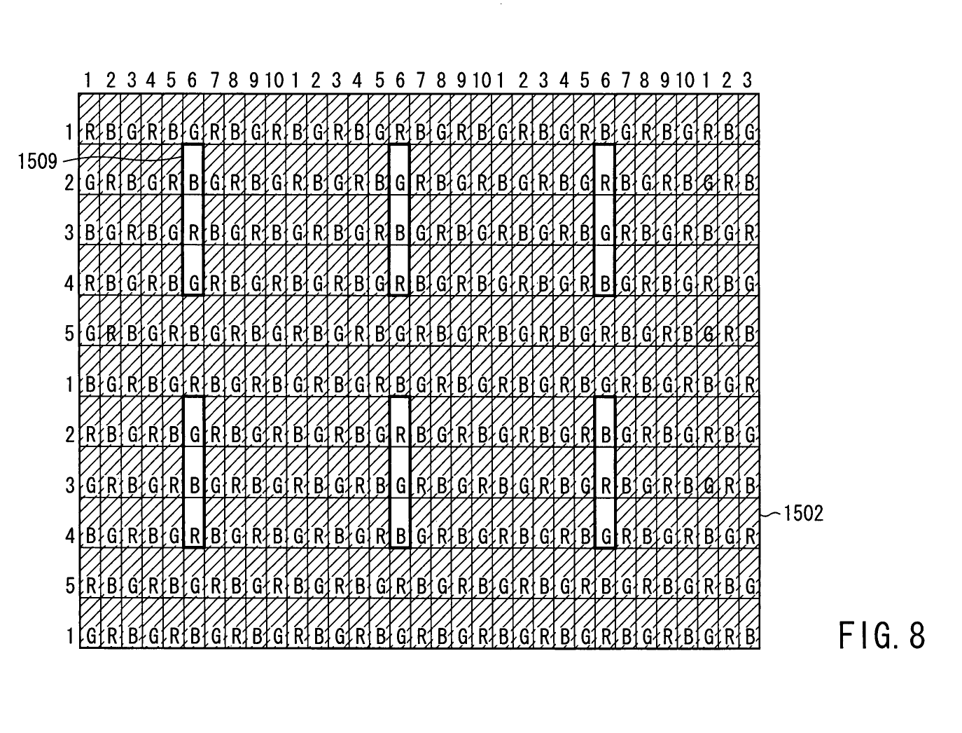

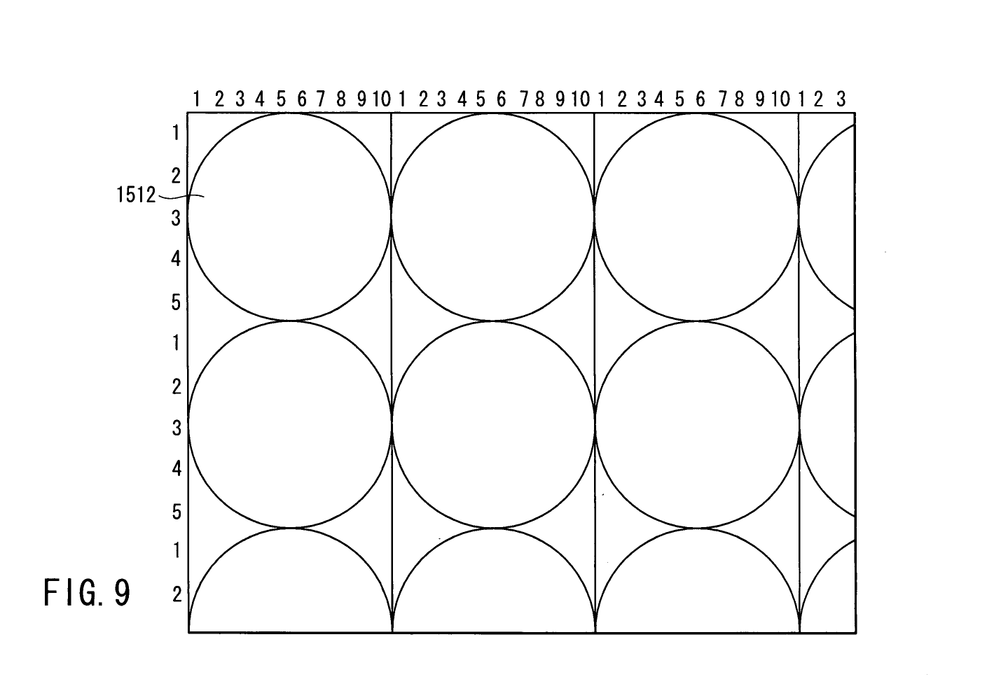

For the liquid crystal display 1501, when light beams from the liquid crystal display 1501 are output through the pinhole array 1502 including the rectangular pinholes 1509 each having, e.g., a width of 50 μm and a length of 150 μm, as shown in FIG. 8, new light-emitting points can be formed by these light beams. The hatched portion in FIG. 8 corresponds to a region where no pixels can be observed because they are shielded by the pinhole array 1502 when viewed directly from the front side. FIG. 9 shows an arrangement that uses the microlens array 1512 in place of the pinhole array 1502.

According to this arrangement, the pixel density in the horizontal direction can be increased. Simultaneously, the pixel density in the vertical direction can be prevented from excessively decreasing. Hence, color flicker can be almost completely suppressed when the eyepoint moves in the horizontal direction, even when the observer who is standing still gazes the image.

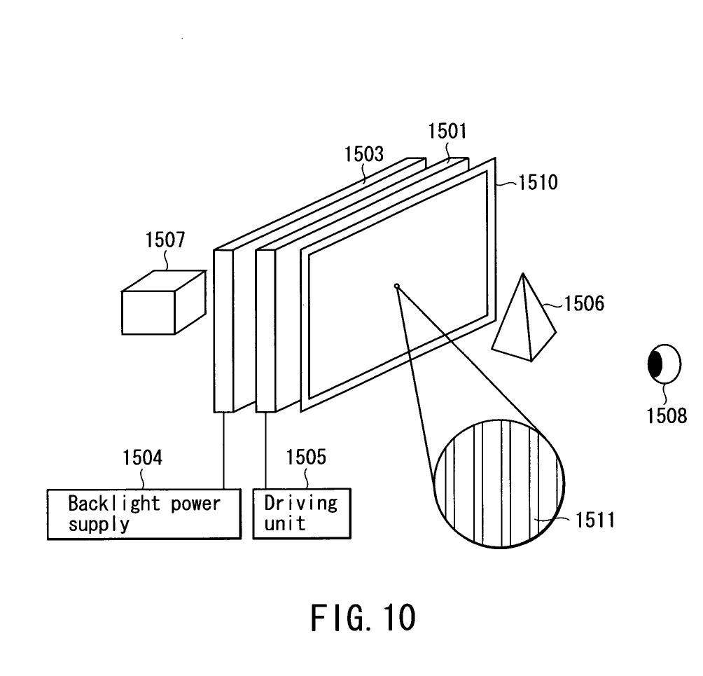

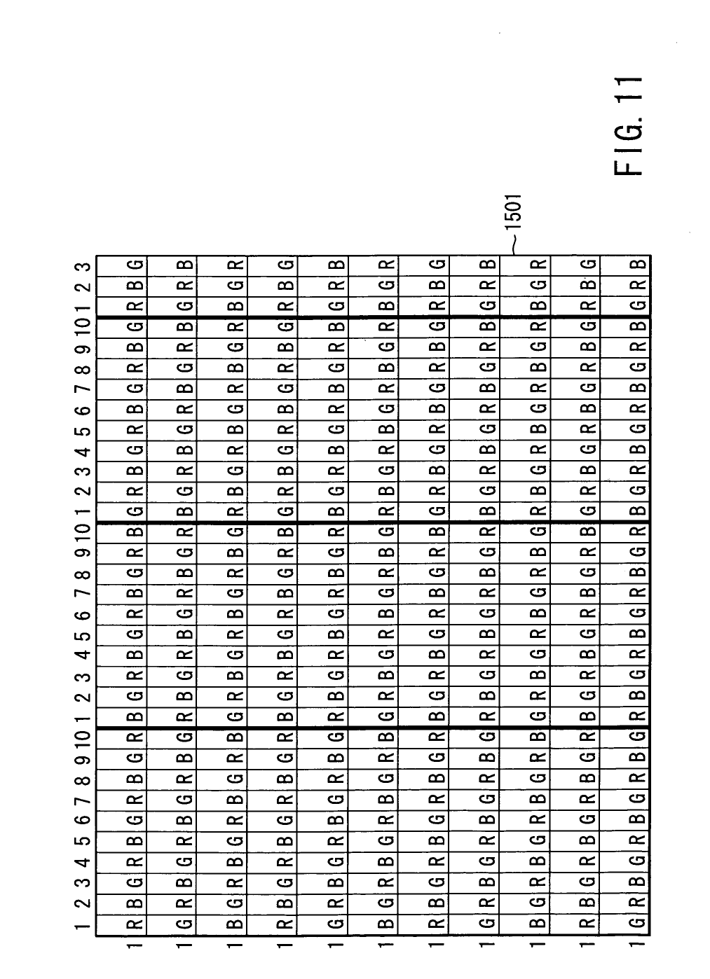

FIG. 10 is a view showing an arrangement having a slit array 1510 in place of the pinhole array 1502. As in the case of the pinhole array, a lenticular sheet may be used in place of the slit array. FIG. 11 shows a plurality of sub regions corresponding to the slit array.

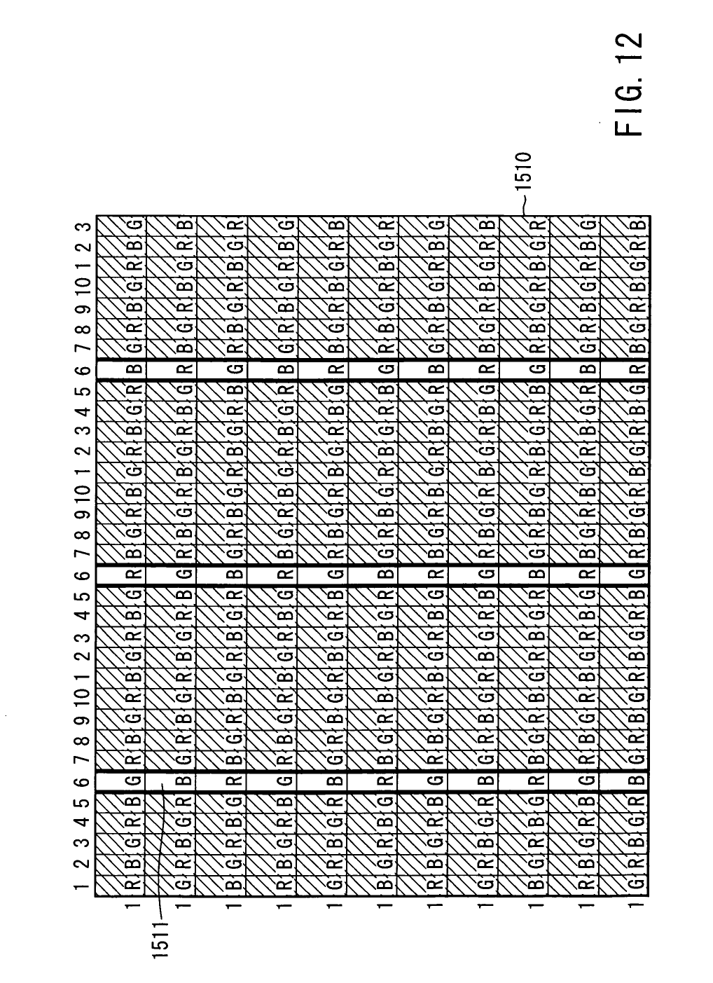

FIG. 12 is a schematic front view of the slit array 1510. The hatched portion in FIG. 12 corresponds to a region where no pixels can be observed because they are shielded by the slit array when viewed directly from the front side. When the slit array 1510 is used, parallaxes in the vertical directions are positively abandoned. A slit array can more easily be manufactured than a pinhole array and can reproduce a natural high-resolution 3D image without any color separation, like a pinhole array. Note that a lenticular sheet may be used in place of the slit array.

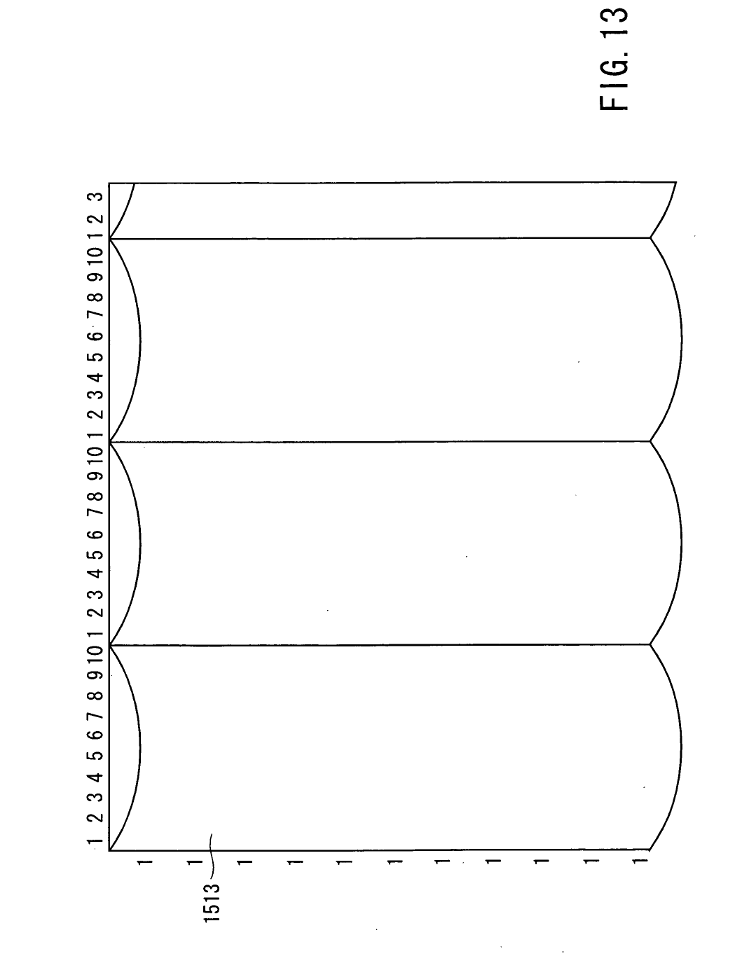

A lenticular sheet has lenses that are one-dimensionally arrayed. Light emerging from a color filter portion corresponding to each sub pixel in the liquid crystal display passes through a lens and horizontally propagates to a specific direction. FIG. 13 shows a lenticular sheet 1513 that can be used in place of the slit array.

According to the first embodiment described above, the sub pixels of the three primary colors of R, G, and B, each of which has a rectangular shape, are arrayed with their longitudinal sides arranged in the vertical direction, as shown in FIG. 6. For this reason, the pixel density in the horizontal direction can be increased as compared to a case wherein sub pixels of the three primary colors of R, G, and B, each of which has a square shape, are arrayed in the vertical direction to make pixel mapping long in the vertical direction.

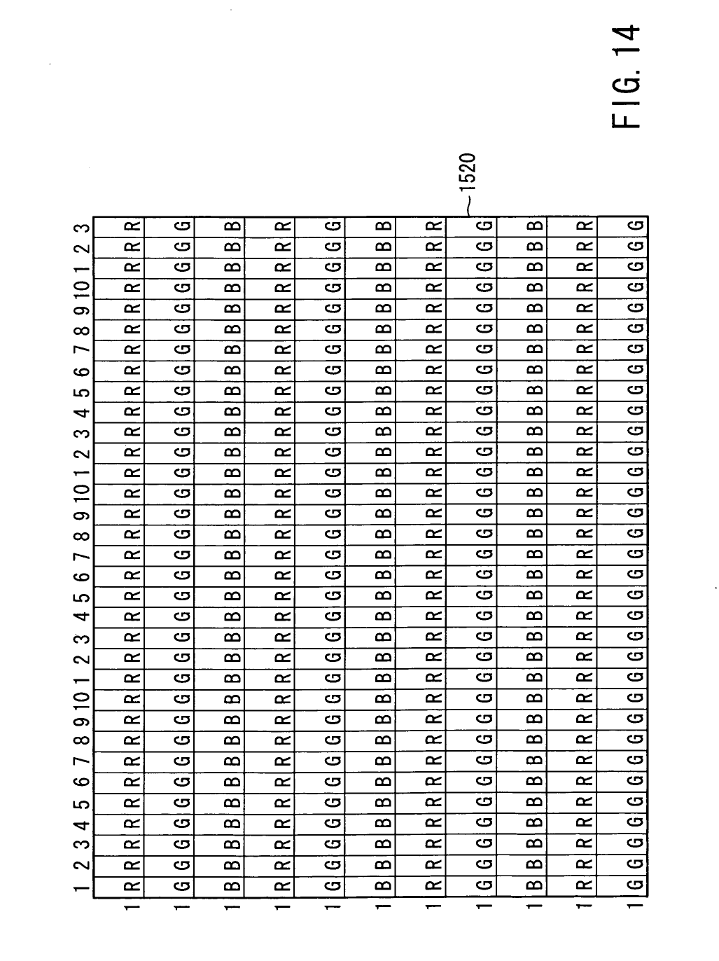

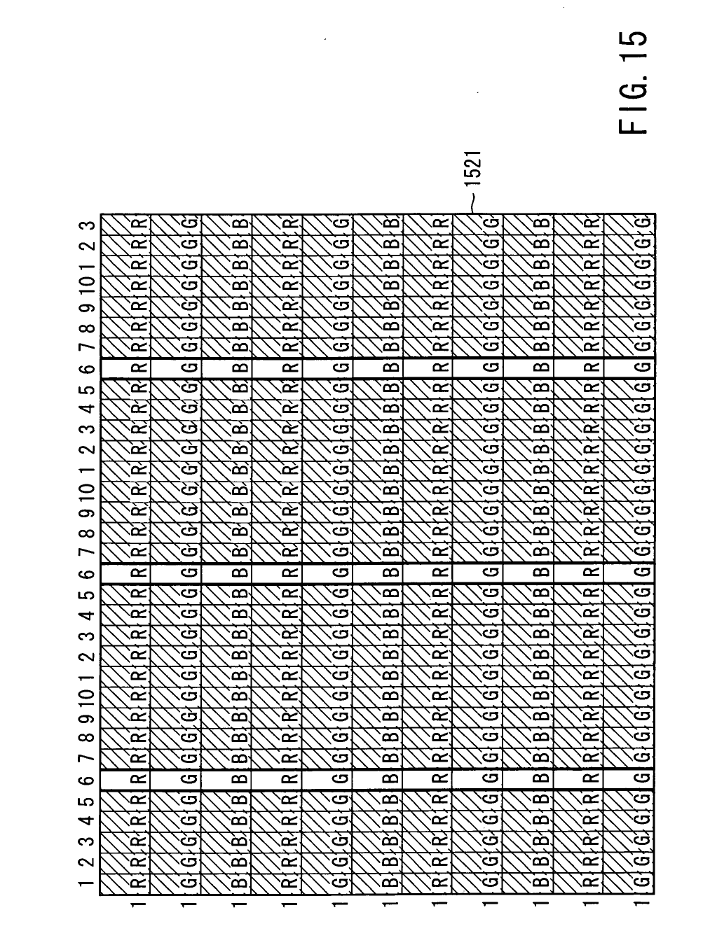

Color flicker due to insufficient RGB color mixture will be described here. Generally, color flicker becomes conspicuous when the pixel size is relatively large. For example, assume that light beams having desired colors and luminances are output from a liquid crystal display 1520 in which pixels (to be referred to as triplets) are formed by arraying R, G, and B sub pixels with their longitudinal sides arranged in the vertical direction, as shown in FIG. 14, through a slit array 1521 as shown in FIG. 15. When the longitudinal length of a pixel exceeds 500 μm, not the desired color but separate R, G, and B colors are observed. The reason for this is as follows. For a given sub pixel that can be seen from a given slit, sub pixels having the same color can always be seen in the horizontal direction through that slit. However, when the longitudinal length increases, the sub pixels are recognized as a band in the horizontal direction.

In the first embodiment having the layout shown in FIG. 6, however, the color flicker can be prevented. This is because for a given sub pixel that can be seen from a given slit, sub pixels having different colors can be seen in the horizontal direction through that slit in most cases. For this reason, the sub pixels are not recognized as a band in the horizontal direction.

### Second Embodiment

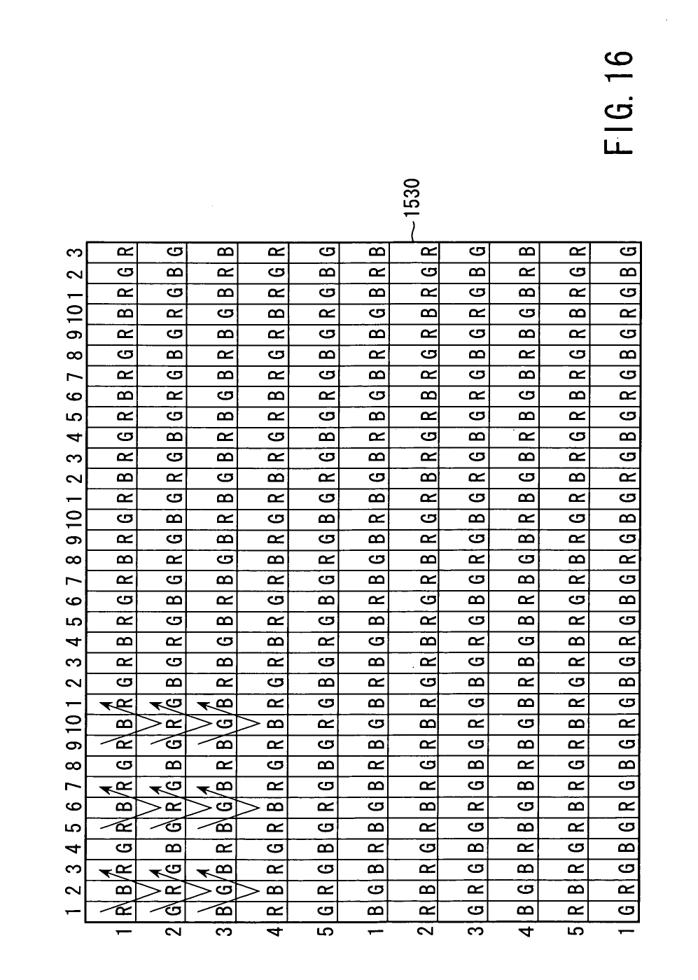

FIG. 16 is a view showing a liquid crystal display according to the second embodiment of the present invention. A liquid crystal display 1530 of the second embodiment is different from the liquid crystal display 1501 of the first embodiment in the pixel layout method, as is apparent from comparison with FIG. 6. The remaining points other than the pixel layout are the same as in the first embodiment. In the layout shown in FIG. 6, sub pixels of the same pixels are laid out in a diagonal pattern toward the lower right. In FIG. 16, however, sub pixels of the same color are laid out in a V-shaped pattern.

Even in the pixel layout of the second embodiment as shown in FIG. 16, sub pixels of the same color are laid out not to be adjacent to each other while sharing their sides.

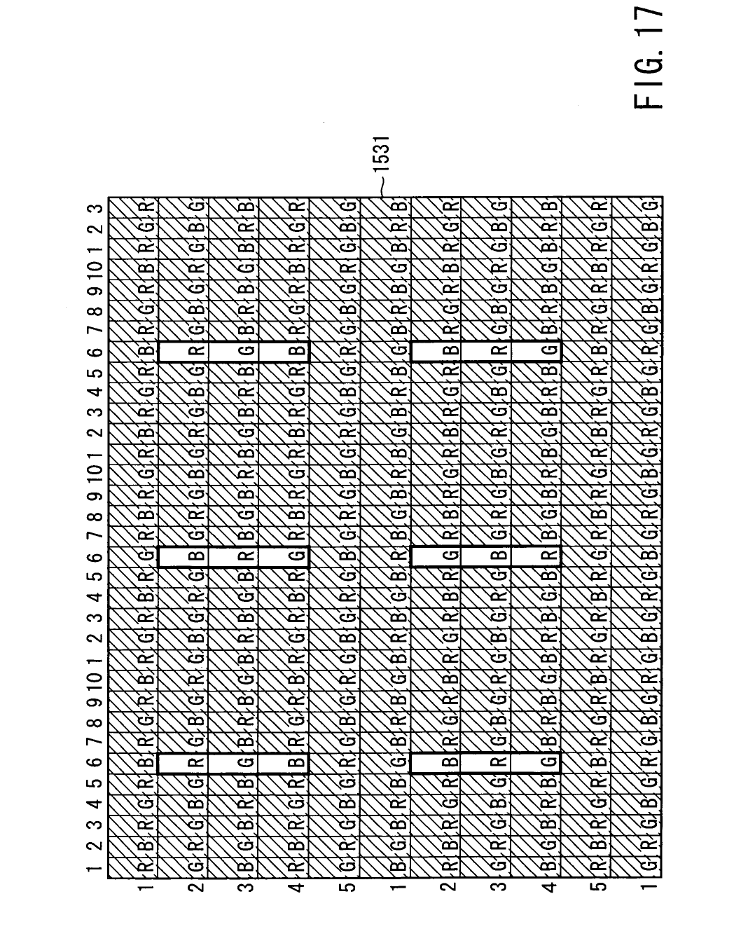

When light beams are output through a pinhole array 1531 having rectangular pinholes each having a width of 50 μm and a length of 150 μm, as shown in FIG. 17, new light-emitting points can be formed by these light beams. Even in the second embodiment, the microlens array 1512 shown in FIG. 9 can be used in place of the pinhole array 1531.

According to the second embodiment, the number of light beams greatly increases, and a natural high-resolution 3D image can be reproduced without any color separation.

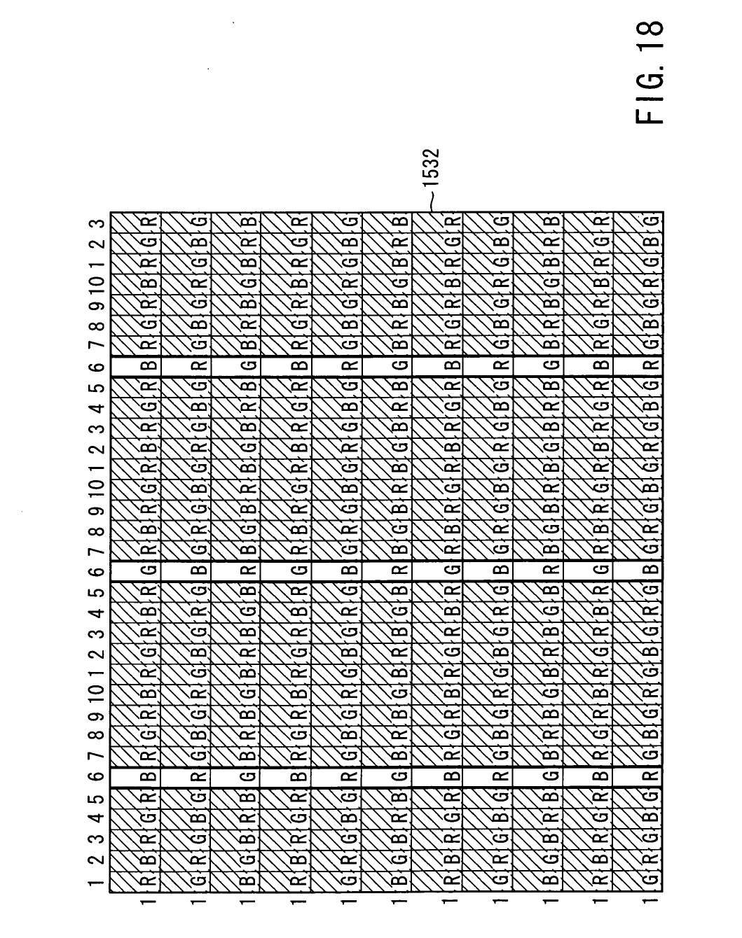

FIG. 18 shows an arrangement in which a slit array 1532 is used in place of the pinhole array 1531 shown in FIG. 17 in correspondence with the pixel layout shown in FIG. 16. In this case, although vertical parallaxes are abandoned, a natural high-resolution 3D image can be reproduced without any color separation. The lenticular sheet 1513 shown in FIG. 13 may be used in place of the slit array 1532.

### Third Embodiment

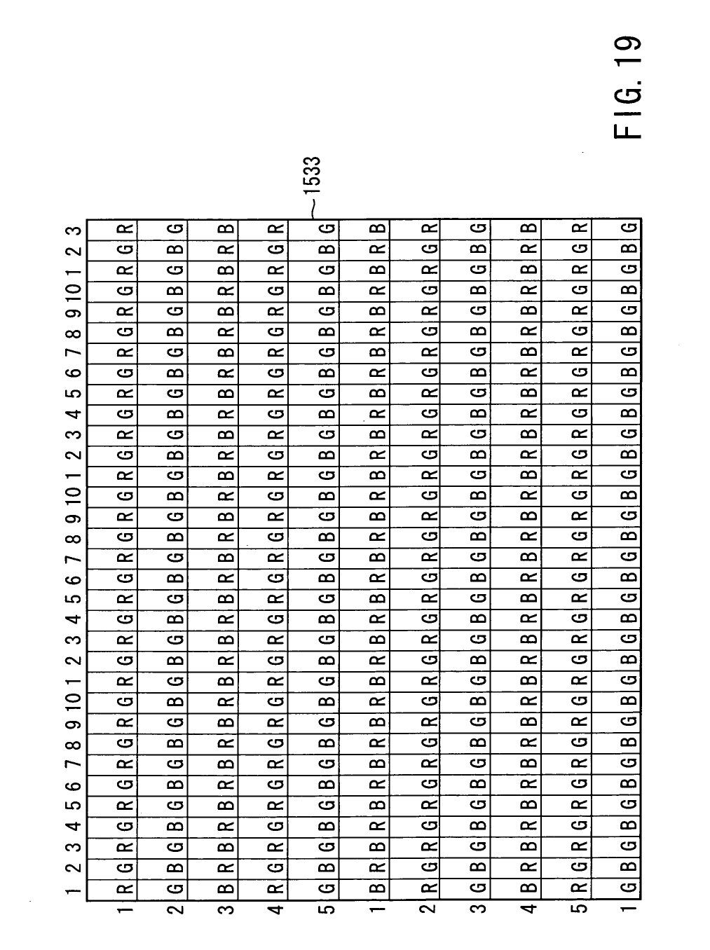

FIG. 19 is a view showing a liquid crystal display according to the third embodiment of the present invention. A liquid crystal display 1533 of the third embodiment is different from the liquid crystal display 1501 of the first embodiment and the liquid crystal display 1530 of the second embodiment in the pixel layout method, as is apparent from comparison with FIGS. 6 and 16. The remaining points other than the pixel layout are the same as in the first and second embodiments.

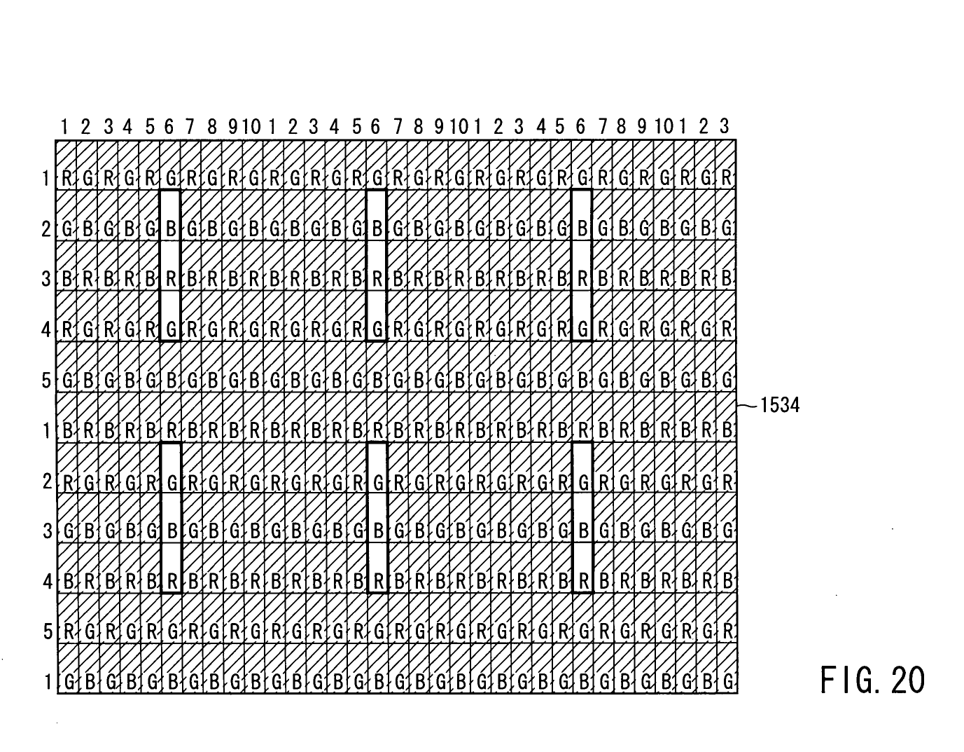

When light beams are output through a pinhole array 1534 having rectangular pinholes each having a width of 50 μm and a length of 150 μm, as shown in FIG. 20, new light-emitting points can be formed by these light beams. Even in the third embodiment, the microlens array 1512 shown in FIG. 9 can be used in place of the pinhole array 1534.

Even according to the second embodiment, the number of light beams greatly increases, and a natural high-resolution 3D image can be reproduced without any color separation, as in the second embodiment.

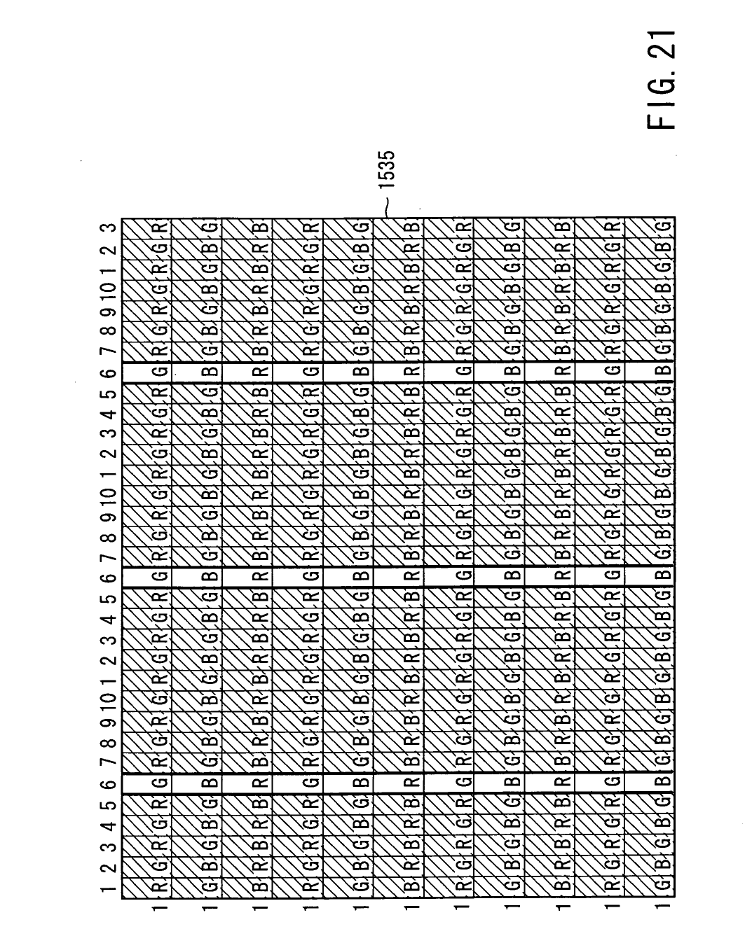

FIG. 21 shows an arrangement in which a slit array 1535 is used in place of the pinhole array 1534 shown in FIG. 20 in correspondence with the pixel layout shown in FIG. 19. In this case, although vertical parallaxes are abandoned, a natural high-resolution 3D image can be reproduced without any color separation. The lenticular sheet 1513 shown in FIG. 13 may be used in place of the slit array 1535.

In the first to third embodiments described above, not the liquid crystal display that constructs the display device, a spontaneous emission type display such as a plasma display or an organic EL (ElectroLuminescence) display may be used. The present invention can be applied to any other electronic display when it forms and displays an image by using R, G, and B sub pixels. In addition, the pixel layout is not limited to the above-described layouts. For example, the layout shown in FIG. 6 may be inverted in the horizontal direction. That is, the pixel layout may be changed from RBGRBG . . . to GBRGBR . . . . Further, the number of parallaxes is not limited to a specific number. The size of the opening of pinhole (slit) may appropriately set to be bigger or smaller than the size of a sub pixel.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A 3D image reproduction apparatus comprising:
a display including a screen on which a plurality of pixels are arranged to display synthesis parallax images in units of arrayed sub regions, wherein each of the pixels includes three sub pixels that differ in color, and the sub pixels are laid out so that adjacent sub pixels differ in color; and
an optical system arranged in front of the screen of the display, forming a 3D image from synthesis parallax images displayed on the screen in units of arrayed sub regions.

2. An apparatus according to claim 1, wherein the synthesis parallax images comprise images raytraced in units of the sub pixels.

3. An apparatus according to claim 1, wherein the synthesis parallax images comprise images synthesized from a plurality of parallax images in units of the sub pixels.

4. An apparatus according to claim 1, wherein the optical system comprises a pinhole array in which pinholes are arranged corresponding to the arrayed sub regions.

5. An apparatus according to claim 1, wherein the optical system comprises a slit array in which slits are arranged corresponding to the arrayed sub regions.

6. An apparatus according to claim 1, wherein the optical system comprises a microlens array in which micro lenses are arranged corresponding to the arrayed sub regions.

7. An apparatus according to claim 1, wherein the optical system comprises a lenticular sheet in which lenses are arranged corresponding to the arrayed sub regions.

8. An apparatus according to claim 1, wherein sub pixels of the same color are laid out in a V-shaped pattern.

9. A 3D image reproduction apparatus comprising:
a display including a screen on which a plurality of pixels are arranged to display synthesis parallax images in units of arrayed sub regions, wherein each of the pixels includes three sub pixels that differ in color, the sub pixels having respectively rectangles extending in a substantially vertical direction of the screen, and the sub pixels are laid out so that adjacent sub pixels differ in color; and
an optical system arranged in front of the screen of the display, forming a 3D image from synthesis parallax images displayed on the screen in units of arrayed sub regions.

10. An apparatus according to claim 9, wherein the synthesis parallax images comprise images raytraced in units of the sub pixels.

11. An apparatus according to claim 9, wherein the synthesis parallax images comprise images synthesized from a plurality of parallax images in units of the sub pixels.

12. An apparatus according to claim 9, wherein the optical system comprises a pinhole array in which pinholes are arranged corresponding to the arrayed sub regions.

13. An apparatus according to claim 9, wherein the optical system comprises a slit array in which slits are arranged corresponding to the arrayed sub regions.

14. An apparatus according to claim 9, wherein the optical system comprises a microlens array in which micro lenses are arranged corresponding to the arrayed sub regions.

15. An apparatus according to claim 9, wherein the optical system comprises a lenticular in which lenses are arranged sheet corresponding to the arrayed sub regions.

16. An apparatus according to claim 9, wherein sub pixels of the same color are laid out in a V-shaped pattern.
